(19) United States
(12) Patent Application Publication
(10) Pub. No.: US 2006/0074629 A1
(43) Pub. Date: Apr. 6, 2006

(54) User-interface language setting method and system

(75) Inventors: Chaucer Chiu, Taipei (TW); Anthony Zhou, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 10/993,720

(22) Filed: Nov. 19, 2004

(30) Foreign Application Priority Data
Sep. 29, 2004 (TW) 093129381

(51) Int. Cl. G06F 17/20

(52) U.S. Cl. 704/8

(57) ABSTRACT

A user-interface language setting method and system is proposed, which is designed for use in conjunction with an information platform for providing a user-interface language setting function for the user to set a preferred language for the user interface on the information platform, so as to allow the user to operate the information platform with his/her preferred language, such as English, Chinese, Japanese, German, and others. This feature allows a user to utilize his/her preferred and most familiar language to operate the information platform.

### BACKGROUND OF THE INVENTION

1. Field of the Invention

This invention relates to information technology (IT), and more particularly, to a user-interface language setting method and system which is designed for use in conjunction with an information platform, such as an intelligent mobile phone, a desktop computer, a notebook computer, a tablet PC, a network workstation, a PDA (Personal Digital Assistant), or the like, for providing a user-interface language setting function for the user to set a preferred language, such as English, Traditional Chinese, Simplified Chinese, Japanese, German, or others, for the user interface of the information platform to display text-based interactive data in the user-specified language, so that the user can operate the information platform through his/her preferred language.

2. Description of Related Art

Information platforms, such as intelligent mobile phones, desktop computers, notebook computers, tablet computers, network workstations, PDA (Personal Digital Assistant) units, and so on, are typically provided with a graphic-based user interface that allows the user to operate the information platform more easily and conveniently in a user-friendly manner.

With the advent of globalization, it is now a common practice in the information technology industry to develop software products, including operating systems and applications, with a user interface coded in various different languages, so as to allow the software products to distribute globally to various countries in the world. Presently, a common practice for globalization is to develop each software product in various language editions. For example, if a software product is intended to be distributed to Chinese, English, Japanese, German, and French speaking countries, then separate efforts are carried out to develop and package the software into a Chinese edition, an English edition, a Japanese edition, a German edition, and a French edition.

One drawback to the foregoing practice, however, is that if a user has purchased a software product in English edition but the user has a need to operate the software through Chinese, then the user will have to purchase another package of the same software product in Chinese edition. This practice is undoubtedly money-wasting and troublesome for the user.

Besides, in the case of intelligent mobile phone or digital camera whose user interface is typically built-in to the device, if a Chinese-speaking user who is unfamiliar with English has purchased a mobile phone or digital camera whose user interface is coded in English, it would undoubtedly very inconveniently and troublesome for the user to operate the device.

### SUMMARY OF THE INVENTION

It is therefore an objective of this invention to provide a user-interface language setting method and system for use with an information platform for the user to arbitrarily select a preferred language for the user interface of the information platform to display all text-based interactive data in the user-selected language, so that the user can conveniently operate the information platform through his/her preferred language.

The user-interface language setting method and system according to the invention is designed for use in conjunction with an information platform, such as an intelligent mobile phone, a desktop computer, a notebook computer, a tablet PC, a network workstation, a PDA (Personal Digital Assistant), and the like, for providing a user-interface language setting function for the user to set a preferred language, such as English, Traditional Chinese, Simplified Chinese, Japanese, German, and so on, for the user interface on the information platform, so that the user can operate the information platform with his/her preferred language. This feature allows a user to utilize his/her preferred language to operate the information platform, without having to purchase a language-specific unit or download language-specific software/firmware.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and object-oriented component model of the user-interface language setting system according to the invention;

FIG. 2 is a schematic diagram showing an example of a language selection interface displayed on screen by the user-interface language setting system of the invention;

FIG. 3A is a schematic diagram showing an example of an English-coded user interface on screen; and

FIG. 3B is a schematic diagram showing the same user interface of FIG. 3A except when the interface language has been changed to Chinese.

### DETAILED DESCRIPTION OF PREFERRED EMBODIMENTS

The user-interface language setting method and system according to the invention is disclosed in full details by way of preferred embodiments in the following with reference to the accompanying drawings.

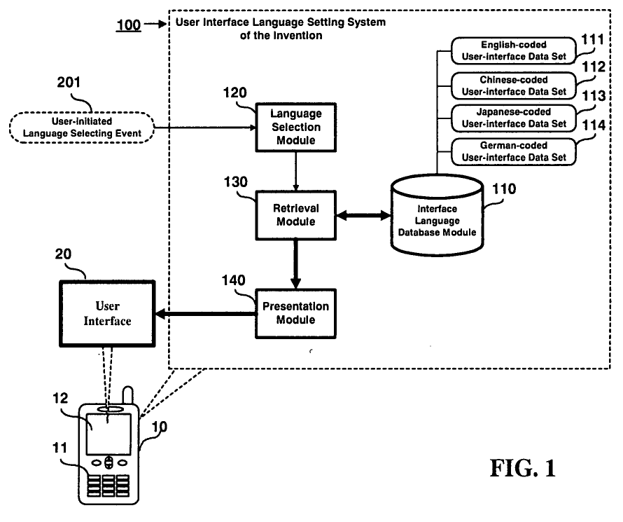

FIG. 1 is a schematic diagram showing the application architecture and object-oriented component model of the user-interface language setting system according to the invention (as the part enclosed in the dotted box indicated by the reference numeral 100). As shown, the user-interface language setting system of the invention 100 is designed for use with in conjunction with an information platform 10 having a software-based user interface 20, such as an intelligent mobile phone, a desktop computer, a notebook computer, a tablet PC, a network workstation, a PDA (Personal Digital Assistant), or the like, for providing a user-interface language setting function for the user to set a preferred language, such as English, Traditional Chinese, Simplified Chinese, Japanese, German, or others, for the user interface 20 to display text-based interactive data (including, for example, menu names, labels, option names and descriptions, status messages, on-line help, and so on) in the user-selected language, so that the user can operate the information platform 10 through his/her preferred language.

For example, if the user interface 20 is factory-preset to English so that it displays all text-based interactive data in English, but the user's native language is Chinese and the user prefers to use Chinese to operate the information platform 10, then the user can activate the user-interface language setting system of the invention 100 to set the interface language to Chinese so as to let the user interface 20 display all text-based interactive data in Chinese, and thereby allow the user to conveniently operate the information platform 10 through his/her preferred language.

In practical implementation, the user-interface language setting system of the invention 100 can be realized by software and integrated as an add-on module to the operating system of the information platform 10.

As shown in FIG. 1, the object-oriented component model of the user-interface language setting system of the invention 100 comprises: (a) an interface language database module 110; (b) a language selection module 120; (c) a retrieval module 130; and (d) a presentation module 140.

The interface language database module 110 is used to prestore a group of text-based user-interface data sets that are coded in a number of prespecified languages, including, for example, an English-coded user-interface data set 111, a Chinese-coded user-interface data set 112, a Japanese-coded user-interface data set 113, and a German-coded user-interface data set 114 (note that in this embodiment, only 4 languages are used for demonstrative purpose, but in practice, it can include more other languages, such as French, Spanish, Korean, and so on). The English-coded user-interface data set 111, the Chinese-coded user-interface data set 112, the Japanese-coded user-interface data set 113, and the German-coded user-interface data set 114 are respectively used to store a set of text-based interactive data that are to be displayed on the user interface 20, including, for example, menu names, labels, option names and descriptions, status messages, on-line help, and so on. For example, if the user interface 20 of the information platform 10 is designed to display a group of menu items and these menu items are coded in English as [File], [Edit], [View], and [Tool], then the corresponding data set stored in the Chinese-coded user-interface data set 112 are, for example, [ [symbol] ], [ [symbol] ], [ [symbol] ] and [ [symbol] ].

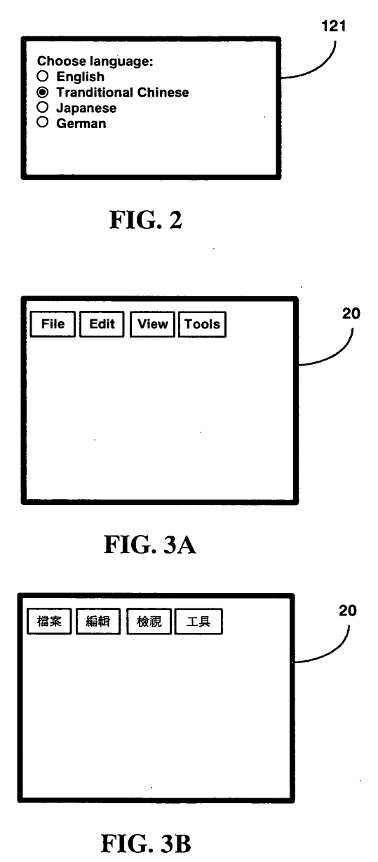

The language selection module 120 is capable of displaying a language selection interface 121, for example as the one shown in FIG. 2, on the screen 12 of the information platform 10 to display a set of language options, including, for example, “English”, “Traditional Chinese”, “Japanese”, and “German”. As the user initiates a language selecting event 201 through the language selection interface 121, for example by using the keyboard 11 or an equivalent input device to select the desired language option, the language selection module 120 will be responsively activated to issue a language retrieval enabling message to the retrieval module 130.

The retrieval module 130 is capable of being activated in response to the language retrieval enabling message from the language selection module 120 to retrieve a corresponding language-specific user-interface data set from the interface language database module 110 (for example, if the user-selected language option from the language selection interface 121 is “Traditional Chinese”, then the retrieval module 130 will retrieve the Chinese-coded user-interface data set 112 from the interface language database module 110), and meanwhile issue a presentation enabling message to the presentation module 140.

The presentation module 140 is capable of being activated in response to the presentation enabling message from the retrieval module 130 to present the language-specific data in the retrieved user-interface data set (111, 112, 113, or 114) on the user interface 20. For example, if the user interface 20 of the information platform 10 currently displays a group of English-coded menus [File], [Edit], [View], and [Tool] as shown in FIG. 3A, then the presentation module 140 will replace these English-coded menu names with corresponding Chinese-coded menu names, i.e., [ [symbol] ], [ [symbol] ], [ [symbol] ], and [ [symbol] ] from the Chinese-coded user-interface data set 112, so as to display the names of the menu items in Chinese instead of English as shown in FIG. 3B.

Referring to FIG. 1, FIG. 2, and FIGS. 3A-3B, in actual application, it is assumed that the user interface 20 the information platform 10 is factory-preset to English as shown in FIG. 3A, and the user wants to use Chinese to operate the information platform 10. In this case, the user needs first to activate the user-interface language setting system of the invention 100, which then activates the language selection module 120 to display a language selection interface 121 on the screen 12 as shown in FIG. 2 for the user to select his/her desired language option. Since the factory-preset language is English, the language selection interface 121 accordingly displays a set of language options in English, including, for example, “English”, “Traditional Chinese”, “Japanese”, and “German”. The user can then utilize the keyboard 11 or an equivalent input device to select his/her desired language option (in this case, the language option “Traditional Chinese”) from the language selection interface 121, causing the occurrence of a language selecting event 201 that activates the language selection module 120 to responsively issue a corresponding language retrieval enabling message to the retrieval module 130. In response, the retrieval module 130 is activated to retrieve the corresponding language-specific user-interface data set, i.e., the Chinese-coded user-interface data set 112, from the interface language database module 110, and meanwhile issue a presentation enabling message to the presentation module 140. In response, the presentation module 140 is activated to present the corresponding language-specific data in the Chinese-coded user-interface data set 112 on the user interface 20. For example, if the user interface 20 of the information platform 10 currently displays a group of English-coded menu items whose names are respectively [File], [Edit], [View], and [Tool] as shown in FIG. 3A, then the presentation module 140 will replace these English-coded menu names with corresponding Chinese-coded menu names, i.e., [ [symbol] ], [ [symbol] ], [ [symbol] ] and [ [symbol] ] from the Chinese-coded user-interface data set 112, so as to display all the menu items in Chinese instead of English as shown in FIG. 3B. This allows the user to operate the information platform 10 through Chinese instead of English.

In conclusion, the invention provides a user-interface language setting method and system which is designed for use in conjunction with an information platform for providing a user-interface language setting function for the user to set a preferred language for the user interface on the information platform, so as to allow the user to operate the information platform with his/her preferred language. This feature allows a user to utilize his/her preferred language to operate the information platform, without having to purchase a language-specific unit or download language-specific software/firmware. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A user-interface language setting method for use on an information platform having a user interface for providing a user-operated interface language setting function for the user interface;
the user-interface language setting method comprising:
building an interface language database module, which prestores a group of language-specific user-interface data sets each storing a set of text-based interactive data coded in a specific language;
and in actual use,
displaying a language selection interface on the information platform to present a set of language options for user-selection;
issuing a language retrieval enabling message in response to a user-initiated language selecting event on the language selection interface;
in response to the language retrieval enabling message, retrieving a corresponding language-specific user-interface data set from the interface language database module; and
presenting the user-interface data in the retrieved language-specific user-interface data set on the user interface.

2. The user-interface language setting method of claim 1, wherein the information platform is an intelligent mobile phone unit.

3. The user-interface language setting method of claim 1, wherein the information platform is a digital camera.

4. The user-interface language setting method of claim 1, wherein the information platform is a desktop computer.

5. The user-interface language setting method of claim 1, wherein the information platform is a notebook computer.

6. The user-interface language setting method of claim 1, wherein the information platform is a tablet computer.

7. The user-interface language setting method of claim 1, wherein the information platform is a PDA (Personal Digital Assistant) unit.

8. A user-interface language setting system for use in conjunction with an information platform having a user interface for providing a user-operated interface language setting function for the user interface;
the user-interface language setting system comprising:
an interface language database module, which prestores a group of language-specific user-interface data sets each storing a set of text-based interactive data coded in a specific language;
a language selection module, which is capable of displaying a language selection interface on the information platform to present a set of language options for user-selection, and which is capable of issuing a language retrieval enabling message in response to a user-initiated language selecting event on the language selection interface;
a retrieval module, which is capable of being activated in response to the language retrieval enabling message from the language selection module to retrieve a corresponding language-specific user-interface data set from the interface language database module; and
a presentation module, which is capable of presenting the user-interface data in the retrieved language-specific user-interface data set on the user interface.

9. The user-interface language setting system of claim 8, wherein the information platform is an intelligent mobile phone unit.

10. The user-interface language setting system of claim 8, wherein the information platform is a digital camera.

11. The user-interface language setting system of claim 8, wherein the information platform is a desktop computer.

12. The user-interface language setting system of claim 8, wherein the information platform is a notebook computer.

13. The user-interface language setting system of claim 8, wherein the information platform is a tablet computer.

14. The user-interface language setting system of claim 8, wherein the information platform is a PDA (Personal Digital Assistant).
